(19) United States
(12) Patent Application Publication
(10) Pub. No.: US 2014/0166577 A1
(43) Pub. Date: Jun. 19, 2014

(54) APPARATUS AND METHOD FOR PRODUCING POTABLE WATER

(71) Applicants: Yasushi Kanzaki, Tokyo (JP); Satoru Hirose, Tokyo (JP)

(72) Inventors: Yasushi Kanzaki, Tokyo (JP); Satoru Hirose, Tokyo (JP)

(73) Assignee: GREEN ARM CO., LTD., Tokyo (JP)

(21) Appl. No.: 14/237,017

(22) PCT Filed: Aug. 1, 2012
(86) PCT No.: PCT/JP2012/069541

§ 371 Date: Feb. 4, 2014

(30) Foreign Application Priority Data
Aug. 4, 2011 (JP) 2011-170844
Oct. 7, 2011 (JP) 2011-222395
Jul. 2, 2012 (JP) 2012-148166

(51) Int. Cl. C02F 1/00; C02F 1/46; C02F 1/68; C02F 1/50; C02F 1/44; C02F 1/42

(52) U.S. Cl. CPC C02F 1/008; C02F 1/441; C02F 1/42; C02F 1/68; C02F 1/50; C02F 1/46
USPC 210/636; 210/106

(57) ABSTRACT

An apparatus according to the present invention includes a pump for pressurizing tap water, a reverse osmosis membrane for separating the pressurized tap water into waste water containing contaminant and filtered water and a tank for storing filtered water. Waste water is disposed through a first flow channel and a second flow channel mounted in parallel. The apparatus according to the present invention further includes a flow rate control unit having a flow rate control valve provided in the first flow channel to control flow rate of waste water flowing through the flow channel, a flow channel open/close valve provided in the second flow channel for opening/closing thereof, and a control device for controlling opening/closing the flow channel open/close valve.

### TECHNICAL FIELD

The present invention relates to an apparatus and a method for producing potable water which contaminant is removed from tap water.

### BACKGROUND

Recently, various equipments and methods have been developed for producing potable water to meet rise in demand for safer potable water. In those equipments and methods, various separation membranes are used to remove contaminant contained in water to be processed. Among the separation membranes, there has been an increase in use of a reverse osmosis membrane (hereinafter, a RO membrane) for equipments installed in ordinary households, hospitals and restaurants because of its ability of removing almost every contaminant contained in water to be processed.

However, equipments and methods for producing potable water which uses using a RO membrane to remove contaminant from tap water may have the following drawbacks.

Firstly, when tap water is supplied onto a RO membrane, contaminant such as ion and salt contained therein is deposited on a surface of a RO membrane along with time and deteriorates filtering efficiency thereof to reduce quantity of filtered water per unit time. Contaminant contained in tap water cannot be fully removed in pre-processing with non-woven fabric or activated charcoal, so formation of a layer of deposited contaminant on a surface of the RO membrane is inevitable. To address this, it is essential to replace a RO membrane at a regular short interval in equipments using a RO membrane. It may be an idea to increase flow velocity of tap water at a surface of a RO membrane to restrict deposition of contaminant to prolong lifespan of the RO membrane, but for this, flow rate of tap water supplied to the membrane should be large, which results in reduction of a ratio of filtered water to supplied tap water.

Secondly, since a RO membrane removes most of chlorine in tap water contained for sterilization, sterilization capacity of obtained filtered water is too low to restrict propagation of saprophytes when contaminated therewith.

Thirdly, since a RO membrane removes most of minerals contained in tap water, water filtered with RO membrane may not be evaluated as so-called “good water” as it is.

The Patent Document 1 discloses an invention for producing potable water using a RO membrane. The Patent Document 1 discloses an apparatus comprising a means for supplying water to be processed to a water production cartridge without using a means for pressurizing the water to be processed and for cleaning the RO membrane of the water production cartridge by flushing. In the apparatus disclosed in the Patent Document 1, a flow channel of waste water from the water production cartridge is branched into a channel passing through a pressure control valve and a channel passing through a flushing valve, and the flushing valve is opened when flushing.

In the invention discloses in the Patent Document 1, water to be processed is supplied onto a RO membrane without pressurizing. The invention allows for obtaining filtered water at a high yield (50% or higher) without pressurizing, owing to use of the RO membrane efficiently operable even at a low pressure. However, cost may be a problem for using such a high-performance RO membrane in a small household apparatus and a method for producing potable water from tap water. Thus, a RO membrane with a general performance, not a low-pressure RO membrane, should be used for such small household apparatus and method for producing potable water. But, when pressure of water to be processed supplied onto a RO membrane is too low due to various conditions, it is not possible to obtain sufficient pressure for allowing a large number of water molecules permeating through ultra-fine pores of a RO membrane, which results in that filtered water may not be obtained at a high yield. Especially, in a household apparatus for producing potable water, a large pressure loss occurs when tap water and/or filtered water permeates through not only a water-producing cartridge but also other filters for removing contaminant, various processing layers for providing necessary quality as potable water and/or small bent pipes adopted for downsizing. Thus, it is required to flow tap water and/or filtered water at a constant pressure to stably obtain potable water, and to apply a stable constant pressure to tap water and/or filtered water such that the yield of potable water is not affected by pressure fluctuation in the supplied tap water. In addition, since removal of a layer of deposited contaminant on a surface of a RO membrane requires flow velocity and flow rate higher than a certain level, deposited contaminant may not be sufficiently removed if the RO membrane is cleaned under a condition where tap water is not pressurized.

The Patent Document 2 discloses an apparatus which automatically cleans a membrane filter in a water purifier. The apparatus comprises a pump for pressurizing water for cleaning a membrane filter when pressure of water supplied onto the membrane filter rises above an appropriate level at immediately upstream thereof, a control part for enabling flushing of water within the membrane filter at a predetermined interval once the pressure of water supplied onto the membrane filter rises above an appropriate level, and a flushing control valve to open/close a flushing pipe for the membrane filter during the flushing operation. The apparatus disclosed in the Patent Document 2 has drawbacks in that, since there is only one flow channel of waste water, performance of the membrane is prone to deteriorate and deposit on the membrane cannot be sufficiently removed. This is because of that the flushing control valve in the apparatus disclosed in the Patent Document 2 is closed when the membrane is not flushed, and the valve is opened only when the membrane is flushed, and, the pressure of water supplied onto the membrane works perpendicular to the membrane while the membrane is not flushed i.e. while water is filtered with the membrane to press contaminant or foreign items into the membrane. As a result, the membrane may not be sufficiently flushed, and it may cause deterioration of the performance of the membrane and make it necessary to frequently replace the membrane.

Backwash may be used as a technique for cleaning a separation membrane. Backwash is a technique for cleaning a membrane by supplying pressurized water from downstream of the separation membrane. Although backwash is effective in removing deposit from a membrane, if a RO membrane is pressurized from the downstream thereof, it is feared that the RO membrane may be peeled from its support. Thus, backwash may not be adopted in a household apparatus for producing potable water using a RO membrane.

The Patent Document 3 discloses a technique for providing anti-bacterial property to water which contaminant is removed by a RO membrane. This technique is for adding metal ion to water processed with a membrane filtering cartridge using an anti-bacterial unit which elutes silver ion from an electrode which a voltage is applied thereto. This technology calls for a power source for adding silver ion because a voltage needs to be applied to the electrode which is an emitting source of silver ion. In addition, a precise control technique is necessary for measuring flow rate of water and applying current according to the flow rate in order to control silver ion concentration.

### PRIOR ART DOCUMENT

The prior art documents referred to in the above and following descriptions are listed below.

Patent Document 1: Laid-Open Japanese Patent Application Publication JP2000-189962A

Patent Document 2: PCT Japanese Publication JP2008-534278A

Patent Document 3: Japanese Patent: JP4661583B

Patent Document 4: Japanese Patent: JP4601361B

### DISCLOSURE OF THE INVENTION

### Problem to be Solved by the Invention

The present invention aims at providing an apparatus and a method for producing potable water which allows for stable and high yield production thereof while achieving prolonged lifespan of a RO membrane. Further, the present invention aims at providing an apparatus and a method for producing potable water which allows for providing appropriate and sustainable anti-bacterial property and for adding minerals to produced potable water for quantity close to that of natural water without any necessity of special control or a power source.

### Means to Solve the Problem

In a first aspect, the present invention provides an apparatus for producing potable water which contaminant in tap water to be processed is removed with a reverse osmosis membrane, sustainable anti-bacterial property is provided and minerals are added thereto. The apparatus comprises a pump for pressurizing tap water, a RO membrane for separating the pressurized tap water into waste water containing contaminant and filtered water, and a tank for storing filtered water. Waste water is disposed through a first flow channel and a second flow channel mounted in parallel. The apparatus further comprises a flow rate control unit having a flow rate control valve provided in the first channel for controlling flow rate of waste water flowing through the first flow channel, a flow channel open/close valve provided in the second channel for opening/closing the second flow channel, and a control device for controlling opening/closing of the flow channel open/close valve. In the apparatus, when producing potable water, the flow channel open/close valve is closed and flow rate is controlled with the flow rate control valve to maintain the flow rate of filtered water. When cleaning the RO membrane, the control device operates to open the flow channel open/close valve while maintaining pressure of tap water to peel contaminant deposited on a surface of the RO membrane.

The flow channel open/close valve is preferably opened at a predetermined interval for a predetermined duration by the control device. The flow channel open/close valve is preferably opened for 10 to 40 seconds once in every 5 to 60 minutes.

In one embodiment of the present invention, the apparatus further comprises a material consisting of silver-containing porous ceramics for adding silver ion to filtered water while coming into contact with the material. Silver ion with concentration of 5 to 90 ppb may be added to filtered water while coming into contact with the material.

In one embodiment of the present invention, the apparatus further comprises a pulse current applying unit for applying pulse current to tap water supplied onto the RO membrane.

In one embodiment of the present invention, the apparatus further comprises a natural stone-filled layer consisting of one or more kinds of natural stone layer for adding minerals to filtered water while permeating through the layer such that hardness and evaporation residue of filtered water are equivalent to those of natural water.

In one embodiment of the present invention, the apparatus further comprises an ion exchange resin layer for removing ion from filtered water which the RO membrane could not remove, and a silver impregnated active charcoal layer for removing radioactive element from filtered water which the RO membrane could not remove.

In a second aspect, the present invention provides a method for producing potable water which contaminant in tap water to be processed is removed with a reverse osmosis membrane, sustainable anti-bacterial property is provided and minerals are added thereto. The method comprises steps of pressurizing tap water, separating the pressurized tap water into waste water containing contaminant and water filtered with a RO membrane, disposing waste water through a first flow channel and a second flow channel mounted in parallel, and storing filtered water in a tank. In the method, when producing potable water, the second flow channel is closed and flow rate of waste water flowing thought the first channel is controlled to maintain the flow rate of filtered water. When cleaning the RO membrane, the second flow channel is opened while maintaining pressurizing tap water to peel contaminant deposited on a surface of the RO membrane. The second flow channel is opened at a predetermined interval for a predetermined duration by the control device. Preferably, the interval of opening of the second flow channel is 5 to 60 minutes and duration of opening the second flow channel is 10 to 40 seconds.

### Effect of the Invention

According to the above configuration, pressurizing tap water supplied onto the RO membrane and maintaining the flow rate of waste water while producing potable water allow for maintaining a ratio of quantity of filtered water to tap water supplied onto the RO membrane at a high level i.e. maintaining a high yield, without being affected by pressure fluctuation of tap water itself. In addition, since cleaning of the RO membrane is performed at a constant interval for a constant duration so as not to reduce effect of each of the cleanings, potable water may be produced without replacing the RO membrane for a long time. Further, application of pulse current to tap water supplied onto the RO membrane reduces amount of deposit on a surface of the RO membrane and makes structure of deposit vulnerable even if deposited so that the deposit may be easily peeled by cleaning the RO membrane. As a result of these effects, the apparatus and the method of the present invention allows for stable and high yield production of potable water while achieving prolonged lifespan of the RO membrane.

The above configuration allows for adding silver ion to potable water as well as setting hardness and evaporation residue within an appropriate range, without any special control and management of current using an electric circuit. As a result, the apparatus and the method of the present invention allows for producing potable water, from tap water, having sustainable anti-bacterial property and quality close to natural water.

### BRIEF DESCRIPTION OF THE DRAWINGS

FIG. 1 is a diagram showing a configuration of an apparatus for producing potable water according to one embodiment of the present invention.

FIG. 2 is a diagram showing flow channels of waste water and a flow rate control unit used for an apparatus for producing potable water according to one embodiment of the present invention.

### BEST MODE FOR CARRYING OUT THE INVENTION

An apparatus and a method for producing potable water according to the present invention will be described in detail with reference to the drawings in the following.

### 1. Outline of Configuration of Apparatus

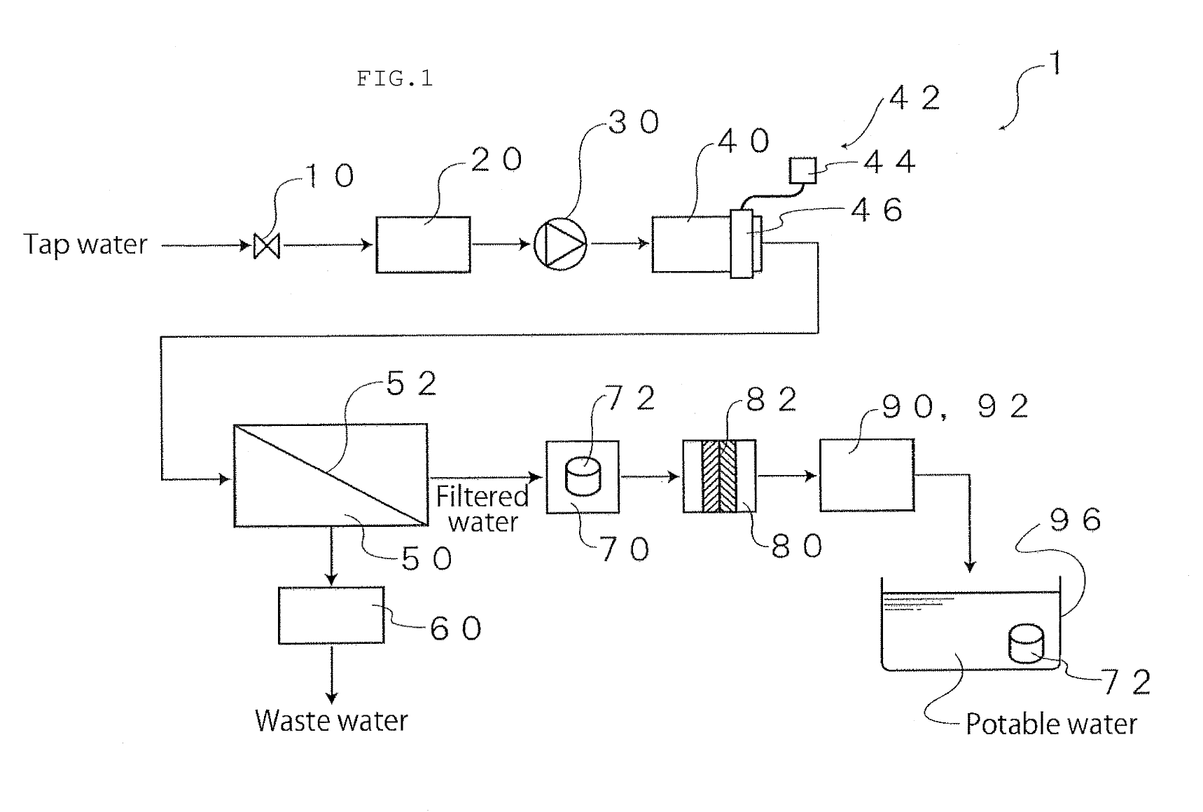

FIG. 1 is a diagram showing a schematic configuration of an apparatus for producing potable water according to one embodiment of the present invention. The apparatus 1 for producing potable water in FIG. 1 has an effective cleaning function of a RO membrane and thereby allows for stable and high yield production of potable water without any replacement of the RO membrane for 3000 hours or longer. The apparatus 1 removes contaminant contained in tap water and then adds silver ion and minerals, and thereby allows for producing potable water from tap water, which is provided with sustainable anti-bacterial property and contains minerals for quantity equivalent to those in natural water.

In the present invention, water to be processed is tap water which is supplied via a water supply valve 10 provided according to necessity at a supply pressure of, in general, about 0.3 to 0.4 MPa.

The apparatus 1 comprises a contaminant removing unit 50 including a RO membrane 52 and a flow rate control unit 60 for controlling flow of waste water from the contaminant removing unit 50. The contaminant removing unit 50 is for separating tap water into filtered water which contaminant therein is removed by the RO membrane 52 and waste water containing contaminant. In the apparatus 1, yield of filtered water may be stably improved and lifespan of the RO membrane 52 may be prolonged owing to controlling flow rate of waste water while producing potable water and cleaning the RO membrane.

The apparatus 1 further comprises a silver ion adding unit 70 for adding silver ion to filtered water from the contaminant removing unit 50 and a mineral adding unit 80 for adding minerals to filtered water. Since chlorine contained in tap water is removed by the RO membrane, propagation of bacteria may not be prevented if filtered water is contaminated with bacteria. To address this, the silver ion adding unit 70 comprises a silver-containing porous ceramics 72 for adding silver ion to filtered water, as filtered water comes into contact with the silver-containing porous ceramics 72, to provide anti-bacterial property thereto.

Since most of minerals contained in tap water are removed by the RO membrane 52, dissolution speed of such filtered water is fast because contaminant is very little which is not considered as desirable for human health. Also, such filtered water is not considered as so-called “good water” as for potable water. To address this, the mineral adding unit 80 of the apparatus 1 comprises a natural stone-filled layer 82 for adding an appropriate amount of minerals to filtered water while filtered water permeates through the natural stone filled layer 82 so that filtered water may become so-called “good water.”

The apparatus 1 further comprises a pump 30 for pressurizing tap water. Although tap water is already pressurized, the supply pressure thereof may be too low for tap water to permeate through the RO membrane if supplied onto the RO membrane as it is, and pressure fluctuation may be generated, and thus, filtered water may not be stably obtained at a high yield. To address this, tap water is pressurized by the pump 30 and flow rate of waste water is appropriately controlled by the flow rate control unit 60 to allow for maintaining quantity of water filtered through the RO membrane to be stably large.

The apparatus 1 may further comprise various pre-processing filters such as, for example, a non-woven fabric filter 20 and an activated charcoal filter 40 in upstream of the contaminant removing unit 50. Since these filters may remove large foreign substance or residual chlorine contained in tap water down to a certain level, they contribute for prolonging lifespan of the RO membrane.

The apparatus 1 may further comprise various post-processing devices such as, for example, an ion exchange resin layer 90 and/or a silver impregnated active charcoal layer 92 in downstream of the contaminant removing unit 50. The RO membrane 52 may remove almost all contaminant contained in tap water, but if the RO membrane 52 is deteriorated for some reason, a very small amount of contaminant may contaminate filtered water. In order to remove such contaminant from filtered water, it is preferable to have filtered water permeate through various post-processing devices such as the ion exchange resin layer 90 and/or the silver impregnated active charcoal layer 92.

Iodine, a radioactive substance, may be removed by filtering with the active charcoal layer 92 in downstream of the ion exchange resin layer 90, because iodine creates a stable compound with silver. An ultraviolet sterilizer 94 for sterilizing filtered water may further be provided.

Produced potable water is stored in a tank 96. Potable water stored in the tank 96 contains silver ion for providing sustainable anti-bacterial property which prevents propagation of saprophytes even if potable water is stored for many hours. The apparatus 1 may further be configured to comprise silver-containing porous ceramics 72 inside the tank 96 in addition to the silver ion adding unit 70. In this case, filtered water may come into contact with silver-containing porous ceramics 72 inside not only the silver ion adding unit 70 but also the tank 96. The apparatus 1 may further be configured to comprise silver-containing porous ceramics 72 only inside the tank 72, without comprising a silver ion adding unit 70. In this case, silver ion will be added to filtered water inside the tank 96. Allowing filtered water to come into contact with silver-containing porous ceramics 72 inside the tank 96 enables anti-bacterial property to be added to filtered water in the tank 96 more effectively.

### 2. Detail of Apparatus and Method for Producing Potable Water

A method for producing potable water is explained in the following, while an apparatus for producing potable water according to one embodiment of the present invention being explained in detail.

### <Pre-Processing Filters>

In one embodiment of the present invention, it is preferable to filter supplied tap water through various pre-processing filters such as, for example, the non-woven fabric filter 20 and/or the active charcoal filter 40 provided upstream of the contaminant removing unit 50. The pre-processing filters may remove a large foreign substance or residual chlorine contained in tap water down to a certain level. The non-woven fabric filter 20 and/or the active charcoal filter 40 used may be ones well-known to those skilled in the art.

### <Pump>

In the present invention, tap water is pressurized by the pump 30 before supplying to the contaminant removing unit 50. Tap water in general is often supplied at a supply pressure of 0.3 to 0.4 MPa, but the supply pressure may fluctuate depending on conditions. Also, the supply pressure of tap water may be different for each of buildings or areas. When the supply pressure of tap water is too low, filtered water may not be stably produced at a high yield even if tap water is supplied on the RO membrane. In order to prevent fluctuation of yield of filtered water caused by the fluctuation of the supply pressure of tap water and to stably produce filtered water, the pump 30 is provided for maintaining the pressure of tap water supplied onto the RO membrane at a constant level. Pressure provided by the pump 30 is about 0.5 to 1.2 MPa. Although an installation position of the pump 30 is not limited, it is preferable not to be immediately upstream of the contaminant removing unit 50, and is more preferable to be between the non-woven fabric filter 20 and the active charcoal filter 40. If the pump 30 were installed immediately upstream of the contaminant removing unit 50, pulsating of tap water induced by pressurizing by the pump 30 may be directly propagated to the RO membrane 52 which may in turn shorten the lifespan of the Ro membrane 52.

### <Contaminant Removing Unit>

Tap water pressurized by the pump 30 and permeated through the non-woven fabric filter and the active charcoal filter 40 is then supplied to the contaminant removing unit 50 for separating into filtered water not containing contaminant and waste water containing contaminant. In the present invention, the RO membrane 52 is used as a membrane for removing contaminant. The RO membrane 52 is a filtering membrane having fine pores of about 0.0001 μm in size which water molecules can permeate therethrough, but contaminant such as ion, salt, organic substance, heavy metal and bacteria cannot. Filtered water after permeating through the RO membrane is purified water with almost no residual contaminant. As the RO membrane 52 used in one embodiment of the present invention, Membrane Filter 75GPD from The Dow Chemical Company may be used. It is preferable, but is not limited, that a spiral-type element incorporating the RO membrane 52 in a pressure vessel is used as the contaminant removing unit 50, and various elements such as a hollow-fiber type and a tubular type may also be used depending on necessity. The contaminant removing unit 50 comprises an inlet of tap water to be pressurized, an outlet of filtered water after permeating through the RO membrane 52, and an outlet of waste water not permeating the RO membrane 52 and containing contaminant.

### <Flow Rate Control Unit>

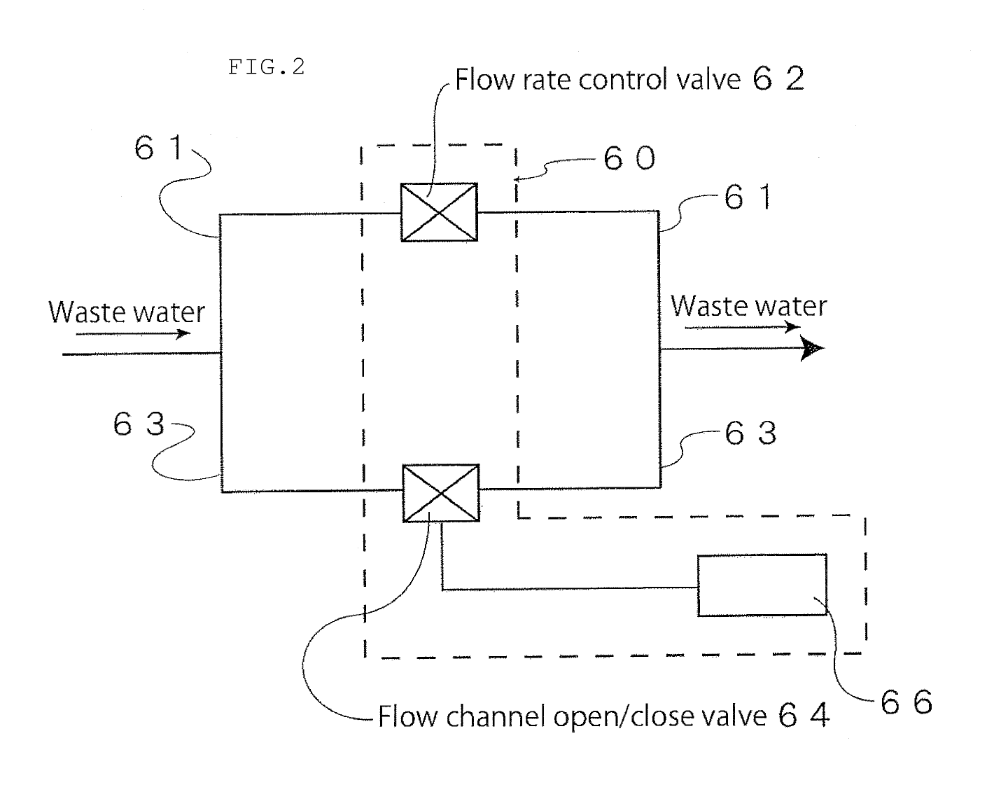

Water not permeated through the RO membrane 52 is disposed as waste water from the contaminant removing unit 50. Waste water contains a part of the contaminant removed by the RO membrane 52. In the present invention, flow rate of waste water is controlled by the flow rate control unit 60. FIG. 2 is a diagram showing a schematic configuration of a first flow channel 61, a second flow channel 63 and the flow rate control unit 60 for waste water of the apparatus according to one embodiment of the present invention. The first flow channel 61 and the second flow channel 63 are provided in parallel as a flow channel of waste water in downstream of the outlet of waste water in the contaminant removing unit 50. The flow rate control unit 60 comprises a flow rate control valve 62 provided in midway of the first flow channel 61 and a flow channel open/close valve 64 provided in midway of the second flow channel 63. When producing potable water, waste water containing contaminant and not permeated through the RO member 52 flows through the first flow channel 61 and the flow rate control valve 62, and the flow channel open/close valve 64 is closed so that waste water does not flows through the second flow channel 63.

When initiating production of potable water, a position of the flow rate control valve 62 i.e. flow rate of waste water is determined so as to produce filtered water at a certain yield or higher. In one embodiment of the present invention, ratio of filtered water to waste water is preferably 1:1 to 2:1. It is preferable to use a needle valve for the flow rate control valve 62 which allows for minute flow control of waste water. Use of a needle valve which allows for minute flow control enables optimizing pressure of tap water supplied to the RO membrane 52 and maintaining flow rate of filtered water to stably improve a yield of filtered water.

The apparatus for producing potable water according to the present invention has a function for prolonging lifespan of the RO membrane 52. Contaminant contained in tap water cannot be completely removed even if tap water is pre-processed with the non-woven fabric filter 20 and/or the active charcoal filter 40. Thus, a layer of deposited contaminant is gradually formed on a surface of the RO membrane 52 along with time of continuous use. As contaminant is deposited on a surface of the RO membrane 52, permeation speed is reduced and volume of filtered water per unit hour is gradually reduced. Therefore, it is necessary to appropriately remove deposited contaminant for stable and high yield production of potable water.

To address the above, as shown in FIG. 2, a flow channel which waste water flows therethrough is branched in the first flow channel 61 and the second flow channel 63 and the flow channel open/close valve 64 is provided in the second flow channel 63, in the apparatus for producing potable water according to the present invention. The flow channel open/close valve 64 is a valve which opens/closes the second flow channel 63. A control device 66 controls an interval between closing the second flow channel 63 and next opening thereof by the flow channel open/close valve 64 and a duration that the second flow channel 63 is kept open. Contaminant deposited on a surface of the RO membrane may be efficiently peeled to be disposed with waste water by opening the flow channel open/close valve 64 for a predetermined duration at a predetermined interval. Pressurizing tap water by the pump 30 is maintained while the flow channel open/close valve 64 is opened. Flow velocity at a surface of the RO membrane 52 is increased by opening the flow channel open/close valve 64 while maintaining tap water pressurized by the pump 30 to increase shear force working on contaminant deposited on the surface of the RO membrane 52 to improve cleaning capacity. It is preferable that the flow channel open/close valve 64 is a solenoid valve for facilitating control by the control device 66.

It is necessary to open the flow channel open/close valve 64 for waste water for an appropriate duration at an appropriate interval in order to prolong lifespan of the RO membrane 52. In the present invention, the flow channel open/close valve 64 for waste water is preferably opened once in about every 5 to 60 minutes, and is more preferably opened once in about every 15 to 45 minutes. And, the flow channel open/close valve 64 for waste water is preferably opened for about 10 to 40 seconds per opening, and is more preferably opened for about 20 to 30 seconds per opening. If an interval between openings of the flow channel open/close valve 64 is short, contaminant may be removed frequently so that the lifespan of the RO membrane 52 is prolonged. But if the interval is too short, it is less effective for removing contaminant and is less economical because most of the supplied water is disposed while the valve 64 is opened which in turn relatively reduces volume of water permeated through the RO membrane. On the other hand, if an interval between openings of the flow channel open/close valve 64 is too long, amount of deposit on a surface of the RO membrane 52 between cleanings increases to make removal of contaminant at every cleaning insufficient, which soon reduces volume of filtered water and results in calling for replacement of the RO membrane 52 at a short cycle. Also, if duration of opening the flow channel open/close valve 64 is too short, contaminant deposited on a surface of the RO membrane 52 cannot be sufficiently removed, and if the duration is too long, it is not economical because volume of waste water increases.

### <Advantageous Effect of the Apparatus of the Present Invention Over the Technique Disclosed in the Patent Document 1>

As explained in the section of Prior Art in the present specification, supplied water was not pressurized both when producing potable water and cleaning the RO membrane in the technique disclosed in the Patent Document 1. This is because a low pressure RO membrane which efficiently operates even if a pressure of water to be processed is low was used in the technique disclosed in the Patent Document 1. On the other hand, tap water is always pressurized by the pump 30 both when producing potable water and cleaning the RO membrane in the present invention using a more general RO membrane. Thus, the apparatus according to the present invention achieves a high yield of filtered water when producing potable water even if a general RO membrane is used, and, an improved cleaning capacity by increasing shear force applied to deposited contaminant on a surface when cleaning the RO membrane.

The apparatus according to the present invention allows for a stable yield of filtered water because tap water is pressurized by the pump 30 to supply to the RO membrane at constant pressure regardless of pressure fluctuation of tap water itself.

### <Advantageous Effect of the Apparatus of the Present Invention Over the Technique Disclosed in the Patent Document 2>

While only a flushing valve for cleaning a membrane is provided in the Patent Document 2, the apparatus according to the present invention comprises the first flow channel 61 and the flow rate control valve 62 for flowing waste water when normally producing potable water, other than the second flow channel 63 and the flow channel open/close valve 64 for cleaning the RO membrane 52. This configuration allows for optimizing pressure of tap water supplied onto the RO membrane 52 when producing potable water to maintain flow rate of filtered water to stably improve a yield thereof, as well as for quickly returning the apparatus to a state where the pressure of tap water supplied to the RO membrane 52 is optimized only by closing the flow channel open/close valve 64 after cleaning the RO membrane 52.

In addition, while a pressure is detected to open/close the flushing valve based on the pressure in the Patent Document 2, the apparatus according to the present invention performs flushing always at a constant cycle. Thus, since the apparatus according to the present invention cleans the RO membrane 52 at a constant interval before an amount of contaminant which cannot be removed by just one opening of the flow channel open/close valve 64 deposits on a surface of the RO membrane 52, potable water may be stably produced at a high yield without any replacement of the RO membrane 52 for a long time.

### <Pulse Current Applying Unit>

In the apparatus according to the present invention, a pulse current applying unit 42 for applying pulse current to tap water may be provided at a certain position in upstream of the contaminant removing unit 50. In one embodiment of the present invention, it is preferable to provide the pulse current applying unit 42 to various pre-processing filters such as the non-woven fabric filter 20 and the active charcoal filter 40 to apply pulse current to tap water permeating through those filters. Although effect of applying pulse current has not been sufficiently clarified, it is inferred that applied pulse current changes magnetic field in pipes to generate mutual repulsion of ion and/or molecules which cause deposits on a surface of a RO membrane to restrict aggregation of ion and/or molecules. In other words, applied pulse current changes magnetic field in pipes to restrict aggregation of contaminant contained in tap water in pipes to reduce formation of deposit on a surface of the RO membrane, when compared a case where pulse current is not applied. Even if deposit is formed, since the structure thereof is vulnerable, it may be easily peeled by cleaning the RO membrane. As a result of the above, performance of the RO membrane is only slowly deteriorated and lifespan thereof is prolonged. Pulse current may be generated using a pulse power source 44 and a coil 46 wound around a circumference of a pipe or an enclosure of a filter which tap water permeates through. In one embodiment of the present invention, it is preferable that the pulse power source 44 generates pulse with a frequency of 50 to 60 Hz, a current value of 1 to 20 mA and a duty ratio of 45 to 55%. Generated pulse current is applied to the coil 46 preferably with 80 to 130 windings arranged on a circumference of an enclosure which preferably houses the non-woven fabric filter 20 and the active charcoal filter 40. Magnetic field generated by the pulse current flowing in the coil allows flowing of the pulse current in tap water. It is preferable that the pulse power source 44 is activated while the pump 30 is operated.

### <Silver Ion Applying Unit>

It is preferable that filtered water which contaminant is removed therefrom after permeating through the contaminant removing unit 50 then permeates through a silver ion adding unit 70 for adding silver ion to filtered water. Chlorine is also removed from filtered water which contaminant is removed therefrom after permeating through the contaminant removing unit 50. Thus, propagation of bacteria may not be prevented if filtered water is contaminated with bacteria etc. Especially, produced potable water may be stored in a tank for a long time in a household apparatus for producing potable water from tap water such as the apparatus according to the present invention, and if potable water in the tank is contaminated with bacteria etc., it is feared that it may adversely affect to human health.

Since silver ion presents very strong sterilizing capacity against bacteria etc. while it has almost no adverse effect to human health, it is increasingly used as a sterilizing material in water purifier in recent years. In the apparatus according to the present invention, it is preferable to add sustainable anti-bacterial property to filtered water by adding silver ion to filtered water permeated through the contaminant removing unit 50. The apparatus according to the present invention may comprise the silver ion adding unit 70 for adding silver ion. The silver ion adding unit 70 has a material consisting of silver-containing porous ceramics 72 which may add silver ion to filtered water when filtered water comes into contact therewith to eventually provide sustainable anti-bacterial property.

It is necessary to add silver ion with concentration of a few ppb or higher to filtered water in order to obtain anti-bacterial property provided by silver ion. In one embodiment of the present invention, a pellet-type material for producing silver-ion-containing water, which consists of the porous ceramics disclosed in the Example 1 of the Patent Document 4, may be used. In this embodiment, the silver ion adding unit 70 is configured such that filtered water permeating through the unit 70 contacts with the pellets. When filtered water comes into contact with the pellets, silver ion elutes to filtered water from the pellets to stably add silver ion with a certain concentration to filtered water without any necessity for an electrical control using a special technique or a complex management of silver ion concentration. Silver ion concentration added using the pellets is about 5 to 90 ppb or less, which may be appropriately adjusted by varying silver content in the pellets or a number of pellets in the silver ion adding unit 70. Although there is no standard for silver ion concentration which adversely affect to human health, United States Environmental Protection Agency (US EPA) stipulates that the upper limit of silver ion concentration is 100 ppb which can be stably satisfied by using the silver containing porous ceramics 72.

Filtered water from the contaminant removing unit 50 is finally stored in the tank 96. It is preferable that various units such as the silver ion adding unit 70, the mineral adding unit 80, the ion exchange resin layer 90 and the silver impregnated active charcoal layer 92 are provided in combination between the contaminant removing unit 50 and the tank 96, but a sequence which filtered water permeates through each of the units is not limited.

### <Mineral Adding Unit>

It is preferable that filtered water from the contaminant removing unit 50 permeates through a mineral adding unit 80 for adding minerals to filtered water. Since filtered water from the contaminant removing unit 50 contains very little contaminant, dissolution speed of such filtered water is fast which is not considered as desirable for human health. Also, since minerals, other than organic substance or microorganism, contained in tap water are in large part removed by the RO membrane 52, such filtered water is safe as potable water but not considered as so-called “good water.” Thus, it is preferable to add appropriate amount of minerals to make filtered water from the contaminant removing unit 50 as good potable water. The apparatus according to the present invention comprises a mineral adding unit 80. In one embodiment of the present invention, the mineral adding unit 80 has a natural stone-filled layer 82 which adds minerals to filtered water while it permeates through the natural stone-filled layer 82 to make filtered water as so-called “good water.” “Society for studying quality of good water” founded by ex-Ministry of Health and Welfare, Japan proposed the following standards for determining quality of good water based on the study result of tap water throughout Japan.
Evaporation residue: 30 to 200 mg/L
Hardness: 10 to 100 mg/L
Free carbon dioxide: 3 to 30
Potassium permanganate consumption: 3 mg/L or less
Odor intensity: 3 or lower
Residual chlorine: 0.4 mg/L or less
Iron: 0.02 mg/L or less
pH: 6.0 to 7.5
Temperature: 20° C. or lower

Each of the above items is a factor that influences quality of water. Especially, minerals such as calcium, magnesium, sodium and potassium are important for quality of good water, and it is necessary to control evaporation residue and hardness at an appropriate value to make water as “good water.”

In one embodiment of the present invention, a natural stone-filled layer 82 combining natural stones which heavy metals etc. giving adverse effect to human health are not eluting therefrom may be used for adding minerals to filtered water permeated through the RO membrane 52 to control evaporation residue and hardness at an appropriate value. The mineral adding unit 80 is provided with the natural stone-filled layer 82 therein. Filtered water entered into the mineral adding unit 80 permeates through the natural stone-filled layer 82 to come out therefrom. Limestone, fossilized coral, quartz or maifan stone may be appropriately combined as natural stones for use in the natural stone-filled layer 82. The natural stone-filled layer 82 may be configured with a plurality of layers each consisting of one type of natural stone or with one layer consisting of a plurality of types of natural stones.

Evaporation residue and hardness are determined depending on a configuration of natural stones in the natural stone-filled layer 82 and retention time of filtered water in the layer 82. In one embodiment of the present invention, it is preferable that hardness of filtered water permeated through the mineral adding unit 80 is 2 to 50 mg/L and evaporation residue thereof is 5 to 100 mg/L, and it is more preferable that hardness of filtered water permeated through the mineral adding unit 80 is 2 to 30 mg/L and evaporation residue thereof is 5 to 50 mg/L. The values of hardness of 2 to 50 mg/L and evaporation residue of 5 to 100 mg/L are equivalent to those of “natural spring water” obtained from snow fell in deep mountains or a glacier after permeating and being filtered through ground for a long period. If hardness is more than 50 mg/L and evaporation residue is more than 100 mg/L, freshness of natural spring water is lost and is not preferable. On the other hand, if hardness is less than 2 mg/L and evaporation residue is less than 5 mg/L, water gives tasteless impression and is not sensed as good by a human. The values of hardness and evaporation residue of filtered water produced by the apparatus and the method according to the present invention do not necessarily match with the above standards of the society for studying quality of good water because the standards of the society for studying quality of good water are based on the study result of tap water and goodness for tap water is not necessarily same as that of natural spring water. The inventors of the present invention aim at producing potable water having equivalent “goodness” as natural spring water by the apparatus and the method according to the present invention.

### <Other Devices>

The RO membrane 52 can remove almost all contaminant contained tap water, but if, by some reason, the RO membrane 52 is deteriorated, a very small amount of contaminant may contaminate into filtered water. In one embodiment of the present invention, it is preferable that to have filtered water permeate through various devices such as the ion exchange resin layer 90 and the silver impregnated active charcoal layer 92 for removing such contaminant. Devices well-known to those skilled in the art may be used as those devices.

An anion exchange resin layer, a cation exchange resin layer or a combination thereof may be used as the ion exchange resin layer 90. Nitrate nitrogen and radioactive substance are required to be removed from filtered water as substances which give adverse effect to human health. It is preferable to provide an anion exchange resin layer in downstream of the RO membrane 52 when a small amount of nitrate nitrogen is found in filtered water. It is preferable to provide a cation exchange resin layer in downstream of the RO membrane 52 when a small amount of cesium is found in filtered water. In other cases, even if any ionized hazardous material permeated through the RO membrane, the hazardous material can be removed from filtered water by appropriately combining the anion exchange resin layer and the cation exchange resin layer.

If a very small amount of radioactive iodine permeated through the RO membrane 52 is found in filtered water, it is preferable to provide the silver impregnated active charcoal layer 92. Since radioactive iodine forms a stable compound with silver, radioactive iodine may be removed by having filtered water permeate through the silver impregnated active charcoal layer.

A sequence which filtered water permeates through the silver adding unit 70, the mineral adding unit 80, the ion exchange resin layer 90 and the silver impregnated active charcoal layer 92 is not limited. For example, it may be provided that filtered water permeates in sequence through the silver impregnated active charcoal layer 92, the ion exchange resin layer 90, the mineral adding unit 80 and the silver adding unit 70. Although the silver adding unit 70, the mineral adding unit 80, the ion exchange resin layer 90 and the silver impregnated active charcoal layer 92 have been described as separate devices, these devices may be configured as one unit. For example, this unit may be configured as that filtered water entered into the unit contacts with the silver containing porous ceramics 72, permeates through the natural stone-filled layer 82, the ion exchange resin layer 90 and the silver impregnated active charcoal layer 92 and comes out from the unit.

Produced potable water is eventually stored in the tank 96. Material and structure of the tank 96 is not particularly limited. In the present invention, even if bacteria etc. contaminates potable water stored in the tank 96, propagation of the bacteria etc. may be prevented because silver ion is added to the produced potable water. The tank 96 may further comprise a material consisting of silver-containing porous ceramics 72 therein. Filtered water stored in the tank 96 may come into contact with the material consisting of silver-containing porous ceramics 72, whereby allowing sustainable anti-bacterial property to be added to filtered water in the tank 96. Although the materials consisting of silver-containing porous ceramics 72 is shown both in the silver ion adding unit 70 and in the tank 96 in FIG. 1, the material consisting of silver-containing porous ceramics 72 may be provided in either one of them or in both of them.

### EXAMPLE

### <Opening Interval of Flow Channel Open/Close Valve for Waste Water, and Quantity and Quality of Filtered Water>

Tap water serviced by Tokyo Metropolitan Government with a supply pressure of 0.3 MPa, a hardness of 63 mg/L and an evaporation residue of 130 mg/L was continuously supplied onto a RO membrane (Membrane Filter 75GPD from The Dow Chemical Company) with a mean pore size of 0.0001 μm to determine a relationship between opening interval of a flow channel open/close valve for waste water and change of quantity of filtered water permeated therethrough. Duration of each of openings of the valve was equally set at 30 seconds. Tap water was pressurized up to 0.8 MPa with a pump and supplied onto the RO membrane at a flow rate of 20 L/h. A flow channel of the waste water was branched into two parallel flow channels, and a flow rate control valve was mounted in one of the two channels and the flow channel open/close valve was mounted in the other of the two channels. A needle valve from Esco Ltd. was used for the flow rate control valve and a solenoid valve from Asco Japan Co., Ltd. was used for the flow channel open/close valve. When initiating a measurement, the flow channel open/close valve was closed and a position of the needle valve was adjusted so that a ratio of filtered water permeating through the RO membrane and waste water was 3:2. For preventing deterioration of the RO membrane, a non-woven fabric filter (5 μm-Sediment Filter from Kent RO Systems Ltd.) and an active charcoal filter from Kent RO Systems Ltd. were mounted in upstream of the RO membrane. Quantity of filtered water when initiating a supply of tap water was 12 L/h.

Table 1 shows a change of a yield of filtered water with time when an interval of opening of the flow channel open/close valve was changed, after initiating supplying tap water. In Table 1, cases where an interval between two openings is 5 minutes, 10 minutes, 30 minutes and 60 minutes are respectively named as Example 1, Example 2, Example 3 and Example 4, and cases where the interval is other than the above are named as Comparative Examples. Time of water supply is a time elapsed from initiating supply of water, and each value at a point of time of water supply shows a relative quantity of filtered water (a yield) at each of the time of water supply where the quantity of filtered water at initiating water supply was 100. When an operating hour of the apparatus for producing potable water is assumed to be 4 hours per day, 1000 hours of operation corresponds to 250 days, 2000 hours to 500 days and 3000 hours to 750 days. The operating hour of 4 hours per day was determined from that, when water used for cooking was assume to be 10 L/time×3 times/day and water for drinking was assumed to be 10 L/day, a daily consumption of 40 L of water may be produced within 4 hours by the apparatus with a filtering capacity of 10 L/h. Filtering capacity of 10 L/h is a mean value of a filtering capacity of 12 L/h when initiating a supply of tap water and that of 7.2 L/h which is 60% of the quantity of when initiating a supply of tap water (a time for replacing the RO membrane), as will be described later.

TABLE 1

| | | Quantity at | Hours of | | |
|---|---|---|---|---|---|
| | | initiating | supply (h) | | |
| | Opening interval | a supply of water | 1000 | 2000 | 3000 |
| Comparative | Every 1 min. | 100 | 96 | 93 | 90 |
| example 1 | | | | | |
| Example 1 | Every 5 min. | | 85 | 76 | 68 |
| Example 2 | Every 10 min. | | 83 | 71 | 66 |
| Example 3 | Every 30 min. | | 82 | 66 | 63 |
| Example 4 | Every 60 min. | | 77 | 65 | 60 |
| Comparative | Every 24 hours | | 58 | 52 | 50 |
| example 2 | | | | | |
| Comparative | No opening | | 32 | | |
| example 3 | | | | | |

Table 1 shows that a yield of filtered water was 60% or more even after 3000 hours of water supply in Example 1 to Example 4. A reason for using a yield of filtered water of 60% or more is that the inventors of the present invention consider that it is ideal to replace the RO membrane when the yield is reduced to less than 60% when deterioration of contaminant removing capacity of the RO membrane due to deposition of contaminant and deterioration of economy due to reduction of the yield were taken into account. For example, more time is necessary to secure required quantity of potable water while a yield of filtered water is reduced. When the yield of filtered water is reduced down to 50%, an operating hour of the apparatus for producing potable water to produce a same quantity of potable water is doubled which exceeds a design capacity of a high-performance apparatus for producing potable water (quantity of filtered water per unit time). In addition, it is uneconomical because power consumption of the apparatus is also doubled. In such a case, a user of the apparatus may be forced to use unfiltered water due to shortage of available potable water, which should be avoided. Further, deterioration of a supply capacity of the apparatus could mean an increase of contaminant permeating into the RO membrane and a permeation of contaminant through the RO membrane into filtered water due to rising of an inner pressure of the RO membrane. Such phenomena represent deterioration of contaminant removing capacity of the RO membrane. Thus, the inventors of the present invention determined that a yield of filtered water at 60% of when initiating a supply of tap water should be an index for a replacement of the RO membrane in order to supply safe potable water.

On the other hand, the values under Comparative Example 2 and Comparative Example 3 show that if an interval between openings is long, filtering capacity is deteriorated in short time and a replacement of the RO membrane is required. The values under Comparative Example 1 where the interval is just 1 minute show that a yield of filtered water is 90% even after 3000 hours of water supply, but even if the RO membrane is cleaned with such a short interval, an effect of cleaning may not be large and most of water supplied to the RO membrane during cleaning is wasted to reduce quantity of water permeating through the RO membrane, and thus it is considered to be not economical. Comparative Example 3 is under a condition assuming a currently popular household apparatus for producing potable water. Most of such apparatus is not provided with a second flow channel having a flow channel open/close valve, and thus, does not have a function to dispose deposits on a surface of the RO membrane by opening the flow channel open/close valve. The values under Comparative Example 3 suggest that filtering capacity of such apparatus for producing potable water is rapidly deteriorated.

Table 2 shows time-series change of amount of evaporation residue (mg/L) after initiating water supply for Example 3, Comparative Example 2 and Comparative Example 3. Filtered water permeated through the RO membrane was sampled to measure the amount of evaporation residue. Table 2 shows that the evaporation residue in filtered water for Example 3 increased only a little even after 3000 hours after initiating water supply. On the other hand, for Comparative Example 2 where the flow channel open/close valve was opened once in every 24 hours and Comparative Example 3 where the flow channel open/close valve was not opened at all, the evaporation residue in filtered water increased along with time, and it is obvious that the contaminant filtering capacity of the RO membrane was deteriorated.

TABLE 2

| | | | Hours of | |
|---|---|---|---|---|
| | | Amount at initiating | supply (h) | |
| | Opening interval | a supply of water | 1000 | 3000 |
| Example 3 | Every 30 min. | 2 | 5 | 7 |
| Comparative | Every 24 hours | | 27 | 38 |
| Example 2 | | | | |
| Comparative | No opening | | 58 | |
| Example 3 | | | | |

Next, a mineral adding unit was mounted in downstream of the RO membrane of the apparatus used for Example 3, Comparative Example 2 and Comparative Example 3 to adjust hardness and evaporation residue in filtered water permeated through the RO membrane. Lime stone from Fukuoka Prefecture, fossilized coral from Okinawa Prefecture, quartz from Hokkaido and maifan stone from Gifu Prefecture were combined and filled in the mineral adding unit as natural stones. Filtered water permeated through the RO membrane contacted with various natural stones in the mineral adding unit and was disposed therefrom. Table 3 shows time-series change of hardness (mg/L) and evaporation residue (mg/L) after adjustment in filtered water after initiating water supply for Example 3, Comparative Example 2 and Comparative Example 3. Example 3-2, Comparative Example 2-2 and Comparative Example 3-2 in Table 3 respectively corresponds to Example 3, Comparative Example 2 and Comparative Example 3 in Table 1.

TABLE 3

| | Amount at initiating | | Hours of supply (h) | | | |
|---|---|---|---|---|---|---|
| | a supply of water | | 1000 | | 3000 | |
| | | Evaporation | | Evaporation | | Evaporation |
| | Hardness | residue | Hardness | residue | Hardness | residue |
| | (mg/L) | (mg/L) | (mg/L) | (mg/L) | (mg/L) | (mg/L) |
| Example 3-2 | 12 | 14 | 12 | 21 | 13 | 26 |
| Comparative | | | 14 | 52 | 15 | 61 |
| Example 2-2 | | | | | | |
| Comparative | | | 16 | 88 | 15 | |
| Example 3-2 | | | | | | |

As previously described, the inventors of the present inventions considers that it is preferable that filtered water permeated through the mineral adding unit has hardness of 2 to 50 mg/L and evaporation residue of 5 to 100 mg/L, and it is more preferable that filtered water permeated through the mineral adding unit has hardness of 2 to 30 mg/L and evaporation residue of 5 to 50 mg/L. Table 3 shows that both hardness and evaporation residue in filtered water in Example 3-2 are in the more preferable range even at 3000 hours after initiating water supply. On the other hand, although the hardness is within the more preferable range for both Comparative Example 2-2 and Example 3-2, the evaporation residue in Comparative Example 2-2 exceeded the more preferable range at 3000 hours after initiating water supply and that in Comparative Example 3-2 exceeded at 1000 hours after initiating water supply.

### <Relationship Between Opening Interval of a First Flow Channel and Quantity of Filtered Water>

A difference between the apparatus disclosed in the Patent Document 2 listed herein as a prior art document and the apparatus according to the present invention is that the apparatus disclosed in the Patent Document 2 does not have a first flow channel and therefore does not have a flow rate control valve, which are provided in the apparatus according to the present invention. In the apparatus disclosed in the Patent Document 2, waste water is generated only when a flushing control valve (corresponds to the flow channel open/close valve in the present invention) is opened. Change in quantity of filtered water is compared between Example 3 and Comparative Example 4 where the flow rate control valve is fully closed and the flow channel open/close valve is opened once in every 30 minutes for 30 seconds. Table 4 shows the result of comparison as relative values of the quantity of filtered water which was 100 at initiating a supply of water. Quantity of filtered water in Comparative Example 4 at initiating a supply of water was higher than that in Example 3 but rapidly decreased with time, which suggests that the RO membrane should be replaced in a short cycle.

TABLE 4

| | Quantity at initiating | Hours of supply (h) | | |
|---|---|---|---|---|
| | a supply of water | 1000 | 2000 | 3000 |
| Example 3 | 100 | 82 | 66 | 63 |
| Comparative Example 4 | 157 | 91 | 42 | |

### <Relationship Between Duration of Opening a Flow Channel Open/Close Valve for Waste Water and Quantity of Filtered Water>

Relationship between duration of opening the flow channel open/close valve and change in quantity of filtered water at 3000 hours after initiating a supply of water was examined using the same apparatus used to examine the relationship between an interval of opening the flow channel open/close valve for waste water and quantity of filtered water. Table 5 shows the result, where the interval of opening was 30 minutes. Example 3 in Table 5 and Example 3 in Table 1 show the results of the same experiment.

TABLE 5

| | Duration of | Quantity at initiating | Quantity at 3000 hours |
|---|---|---|---|
| | opening | a supply of water | after initiating supply |
| Example 3 | 30 sec | 100 | 63 |
| Example 5 | 15 sec | | 62 |
| Comparative | 5 sec | | 56 |
| Example 5 | | | |
| Comparative | 60 sec | | 63 |
| Example 6 | | | |

Table 5 shows that quantity of filtered water at 3000 hours after initiating a supply of water in Example 3 and Example 5 are still 60% or more than that at initiating the supply. On the other hand, when duration of opening the flow channel open/close valve is short as in Comparative Example 5, the filtering capacity of the RO membrane is deteriorated in short period of time and a replacement of the RO membrane is required accordingly. Quantity of filtered water at 3000 hours after initiating a supply of water is still 60% or more than that at initiating the supply in Comparative Example 6 where duration of opening the flow channel open/close valve is 60 seconds, but when the duration is too long like in Comparative Example 6, it is not economically desirable because quantity of waste water also increases.

### <Silver Ion Concentration>

A silver ion adding unit was mounted in downstream of the RO membrane in the apparatus used in Example 1 to Example 4 and change in silver ion concentration in filtered water permeated through the silver ion adding unit was measured. A pellet-type material for producing silver-ion-containing water, which consists of porous ceramics produced according to the method disclosed in the Example 1 in the Patent Document 4, was used for about 5 grams in the silver ion adding unit. Filtered water permeated through the RO membrane then permeated through the silver ion adding unit in contact with the pellet-type material for producing silver-ion-containing water therein and was disposed therefrom. The maximum value of silver ion concentration from initiating a supply of water until 500 hours after the initiating was 32 ppb, the minimum value of the same was 11 ppb, and the mean value was 20 ppb. This shows that the silver ion concentration in the filtered water is controlled to sustain necessary anti-bacterial property, as well as not to exceed 100 ppb stipulated in the U.S. Environmental Standard by the USEPA. Thus, it shows that water filtered in the apparatus of the present invention is safe.

### <Process of Water Containing Radioactive Substance>

Removal of radioactive substance was tested by continuously supplying water to be processed containing radioactive substance onto a RO membrane (Membrane Filter 75GPD from the Dow Chemical Company) with a mean pore diameter of 0.0001 μm. The water to be processed was pressurized up to 0.5 MPa with a pump and supplied onto the RO membrane at a flow rate of 10 L/h. A flow channel for waste water was branched into 2 parallel channels, and a flow rate control valve was mounted in one of the 2 branch channels and a flow channel open/close valve was mounted in the other of the 2 branch channels. A needle valve from Esco Ltd. was used for the flow rate control valve and a solenoid valve from Asco Japan Co., Ltd. was used for the flow channel open/close valve. The flow channel open/close valve was closed when initiating a measurement and the flow rate at the needle valve was adjusted so that a ratio of filtered water permeated through the RO membrane and the waste water was 3:2 to 2:1. For preventing deterioration of the RO membrane, a non-woven fabric filter (5 μm-Sediment Filter from Kent RO Systems Ltd.) and an active charcoal filter from Kent RO Systems Ltd. were mounted in upstream of the RO membrane. Quantity of filtered water when initiating a supply of the water to be processed was 6 L/h.

Type of radioactive substance contained in the water to be processed and radioactivity concentration thereof were as follows. The radioactivity concentration was detected with a germanium semiconductor detector from Canberra Industries Inc. which a detection threshold thereof is 10 Bq/kg. Iodine-131 was not detected.

Water to be processed: Cesium-134: 400 Bq/kg
Cesium-137: 460 Bq/kg

Radioactivity concentration in filtered water and waste water after processing was as follows.

Filtered water: Not detected

Waste water: Cesium-134: 980 Bq/kg
Cesium-137: 1,100 Bq/kg

The above result shows that the radioactive substance contained in the water to be processed was all removed by the RO membrane and transferred to the waste water.

### NUMERICAL SYMBOLS

1: Apparatus for producing potable water
10: Water supply valve
20: Non-woven fabric filter
30: Pump
40: Active charcoal filter
42: Pulse current applying unit
44: Pulse power source
46: Coil
50: Contaminant removing unit
52: RO membrane
60: Flow rate control unit
61: First flow channel
62: Flow rate control valve
63: Second flow channel
64: Flow channel open/close valve
66: Control device
70: Silver ion adding unit
72: Silver containing porous ceramics
80: Mineral adding unit
82: Natural stone-filled layer
90: Ion exchange resin layer
92: Silver impregnated active charcoal layer
96: Tank

1. An apparatus for producing potable water which contaminant in tap water to be processed is removed with a reverse osmosis membrane, sustainable anti-bacterial property is provided and minerals are added thereto, the apparatus comprising:
a pump for pressurizing tap water;
a reverse osmosis membrane for separating the pressurized tap water into waste water containing contaminant and filtered water;
a first flow channel and a second flow channel mounted in parallel and the waste water flows through;
a flow rate control unit having a flow rate control valve provided in the first channel for controlling flow rate of waste water flowing through the first flow channel, a flow channel open/close valve provided in the second channel for opening/closing the second flow channel, and a control device for controlling opening/closing of the flow channel open/close valve; and
a tank for storing the filtered water,
wherein, when producing potable water, the flow channel open/close valve is closed and the flow rate at the flow rate control valve is controlled to maintain the flow rate of the filtered water, and when cleaning the reverse osmosis membrane, the control device operates to open the flow channel open/close valve while maintaining the pressure of the tap water to peel contaminant deposited on a surface of the reverse osmosis membrane.

2. The apparatus for producing potable water as defined by claim 1, wherein the flow channel open/close valve is opened at a predetermined interval for a predetermined duration by the control unit.

3. The apparatus for producing potable water as defined by claim 2, wherein an interval of opening of the flow channel open/close valve is 5 to 60 minutes and duration of opening the flow channel open/close valve is 10 to 40 seconds.

4. The apparatus for producing potable water as defined by claim 1, the apparatus further comprises a material consisting of silver-containing porous ceramics for adding silver ion to the filtered water while the filtered water is coming into contact therewith.

5. The apparatus for producing potable water as defined by claim 4, wherein concentration of silver ion contained in the filtered water after contacting with the material is 5 to 90 ppb.

6. The apparatus for producing potable water as defined by claim 1, the apparatus further comprises a pulse current applying unit for applying pulse current to tap water supplied to the reverse osmosis membrane.

7. The apparatus for producing potable water as defined by claim 1, the apparatus further comprises a natural stone-filled layer consisting of one or more types of natural stone for adding minerals to the filtered water while the filtered water is permeating therethrough so that hardness and evaporation residue of the filtered water becomes equivalent to those of natural water.

8. The apparatus for producing potable water as defined by claim 1, the apparatus further comprises an ion exchange resin layer between the reverse osmosis membrane and the tank for removing ion which the reverse osmosis membrane could not remove from the filtered water and a silver impregnated active charcoal layer for removing radioactive element which the reverse osmosis membrane could not remove from the filtered water.

9. A method for producing potable water which contaminant in tap water to be processed is removed with a reverse osmosis membrane, sustainable anti-bacterial property is provided and minerals are added thereto, the method comprising steps of:
pressurizing tap water;
separating the pressurized tap water into waste water containing contaminant and filtered water;
disposing the waste water via a first flow channel and a second flow channel mounted in parallel; and
storing the filtered water in a tank,
wherein, when producing potable water, the second flow channel is closed and the flow rate of the waste water flowing through the first flow channel is controlled to maintain the flow rate of the filtered water, and when cleaning the reverse osmosis membrane, the second flow channel is opened while maintaining the pressure of the tap water to peel contaminant deposited on a surface of the reverse osmosis membrane.

10. The method for producing potable water as defined by claim 9, wherein the second flow channel is opened at a predetermined interval for a predetermined duration.

11. The method for producing potable water as defined by claim 10, wherein the interval of opening the second flow channel is 5 to 60 minutes and duration of opening the second flow channel is 10 to 40 seconds.

12. The method for producing potable water as defined by claim 9, the method further comprises a step of adding silver ion to the filtered water by making the filtered water contact with a material consisting of silver-containing porous ceramics.

13. The method for producing potable water as defined by claim 12, wherein the concentration of silver ion contained in the filtered water after contacting with the material is 5 to 90 ppb.

14. The method for producing potable water as defined by claim 9, the method further comprises a step of applying pulse current to tap water supplied to the reverse osmosis membrane.

15. The method for producing potable water as defined by claim 9, the method further comprises a step of adding minerals to the filtered water by making the filtered water permeate through a natural stone-filled layer consisting of one or more types of natural stone so that hardness and evaporation residue of the filtered water becomes equivalent to those of natural water.

16. The method for producing potable water as defined by claim 9, the method further comprises a step of removing ion which the reverse osmosis membrane could not remove from the filtered water by making the filtered water permeate through an ion exchange resin layer and removing radioactive element which the reverse osmosis membrane could not remove from the filtered water by making the filtered water permeate through a silver impregnated active charcoal layer.
